(19) United States
(12) Patent Application Publication
(10) Pub. No.: US 2025/0136343 A1
(43) Pub. Date: May 1, 2025

(54) MULTI-MATERIAL CARBONATED PERISHABLE PACKAGING

(71) Applicant: Bubbled Box, LLC, Grand Rapids, MI (US)

(72) Inventors: John W. Green, Grand Rapids, MI (US); Grant Hemingway, Napa, CA (US); David W. Baarman, Fennville, MI (US)

(21) Appl. No.: 18/931,270

(22) Filed: Oct. 30, 2024

Related U.S. Application Data
(60) Provisional application No. 63/546,594, filed on Oct. 31, 2023.

(51) Int. Cl. B65D 77/06; A23L 2/54; B01F 23/2361; B01F 23/237; B01F 35/71; B01F 101/14; B65B 3/04; B65D 75/26; B65D 75/56; B65D 75/58; B65D 85/72

(52) U.S. Cl. CPC B65D 77/067; A23L 2/54; B01F 23/2361; B01F 35/712; B01F 35/71805; B65B 3/045; B65D 75/26; B65D 75/566; B65D 75/5877; B65D 85/72; B01F 23/237621; B01F 2101/14

(57) ABSTRACT

A package for storage and dispensing of carbonated beverages. In one aspect, the package generally includes a collapsible, flexible liquid enclosure housed within an external container where the external container is precisely configured to correspond in size and shape with the liquid enclosure when the liquid enclosure is filled to the desired maximum volume. As such, the internal liquid enclosure and the external container cooperate to constrain the internal pressure of the filled liquid enclosure. The external container may be generally sleeve-like with top and bottom ends closed by end caps. In one aspect, the liquid enclosure may include a valve fitment seating a conventional Schrader valve through which fluid can be introduced into and dispensed from the liquid enclosure. The present invention also provides a method of filling a package in which the liquid is not carbonated until after it has been introduced into the liquid enclosure.

The present invention relates to packaging systems and more specifically to packaging for carbonated beverages.

There is an ongoing need to distribute carbonated beverages in packaging suitable for consumer use. Given the presence of dissolved carbon dioxide, the packaging of carbonated beverages presents a number of unique challenges. For example, it is generally desirable to retain as much of the dissolved carbon dioxide as possible in the beverage, which can improve taste and other aesthetic characteristics of the beverage. To help maintain carbonation, it is generally desirable to maintain the packaged beverage under pressure and to limit exposure of the beverage to ambient air. While these objectives are well-known, experience has revealed that it is difficult to provide economical packaging that is suitable for use in distributing carbonated beverages to consumers.

While a variety of packages have been developed for use in packaging and dispensing carbonated beverages, existing packages of this type suffer from one or more shortcomings. Accordingly, there remains a long-felt and unmet need for a packaging solution that not only provides improved performance, but also facilitates filling and pressurizing carbonated beverages.

### SUMMARY OF THE INVENTION

The present invention provides a single-use consumer package intended for packaging, storing and dispensing carbonated beverages sold to consumers. A carbonated beverage package in accordance with the present invention may incorporate one or more of a variety of features described and disclosed herein. Packages manufactured in accordance with one aspect of the present invention include a collapsible, flexible liquid enclosure housed within an external container where the external container is precisely configured to correspond in size and shape with the liquid enclosure when the liquid enclosure is filled to the desired maximum volume. As such, the internal liquid enclosure and the external container cooperate to constrain the internal pressure of the liquid enclosure when it is filled to the desired maximum volume.

In one embodiment, the internal liquid enclosure is a flexible bag that is initially provided flat and empty. The bag expands as it is filled eventually reaching a predetermined maximum size and shape. The external container is configured to define an internal space that corresponds in size and shape to the maximum size and shape of the internal bag, such that the internal bag and the external container cooperative constrain the pressure provided by the carbonated beverage when the internal bag is filled. The flexible bag may be a foil lined bag.

In one embodiment, the internal bag is formed from one or more sheets of material. In one embodiment, the internal bag is formed by folding a sheet into the desired shape and joining the free edges to create an enclosure. In an alternative embodiment, the internal bag is formed by joining the edges of at least two sheets adjacent sheets. The sheet material may be joined using essentially any leaktight attachment, such as welding or adhesives, that is able to withstand the anticipated internal pressures. The size, shape and configuration of the seams may vary from application to application to meet the applicable strength and durability requirements.

In one embodiment, the internal bag has a generally cylindrical shape when filled and opposite ends of the cylinder are closed by the introduction pleats or gussets formed with large seams in overlapping portions of the material.

In one embodiment, the package includes resilient foam inserts that are fitted into the pleated ends of the package. Each form insert designed and shaped to be fitted into the negative space between the pleated end of the package and the corresponding end cap.

In one embodiment, the external container is formed by a segment of conventional cardboard tube. In those embodiments in which the external container is a cylindrical tube, opposite ends of the tube may be closed by end caps. The end caps may be configured to be fitted tightly into opposite ends of the tube. The end caps have may have structural features that engage and interface with the inner surface of the tube. For example, the outer surface of each end cap may have a plurality of tapered circumferential ribs that interface with the inside of the tube. The ribs may be tapered or angled in a way that allows relatively easy insertion of the end cap into the tube, but resists movement of the end cap in the opposite direction. For example, the circumferential wall of the end cap may include a plurality of annular barb-like structures. In addition or as an alternative, the end caps may be secured in place within the tube by fasteners and/or adhesives. For example, each end cap may be stapled, riveted or cemented in place within the tube. As another example, the end cap may have one or more protrusions that mechanically interlock with corresponding features in the tube.

In one embodiment, one or both of the end caps may configured to be selectively movable into the interior of the external container to reduce the size of the internal space containing liquid enclosure. In some applications, movement of an end cap can be used to maintain a tight enclosure around the liquid enclosure and/or to press the contents from liquid enclosure.

In one embodiment, the liquid enclosure includes an integral valve fitment. The integrated valve fitment may include a valve that is capable of resisting the internal pressure in the liquid enclosure. In one embodiment, the valve includes a Schrader valve.

In one embodiment, the package includes a dispensing spout configured to be fitted to the integral valve fitment. The dispensing spout includes a plunger arrangement configured to allow a consumer to selectively manipulate the valve to dispense the carbonated beverage through the spout. The valve fitment may be disposed on the side of the liquid enclosure toward the bottom so that gravity assists with the dispensing of the contained beverage. The dispensing spout may be removable so that the package can be filled, stored and delivered without the plunger in place. The package may include an integrated storage space where the dispensing spout can be stored when not in use.

In another aspect, the present invention provides a method for filling a package and carbonating a beverage. In one embodiment, the method includes the steps of providing an expandable liquid enclosure that includes a valve fitment through which a liquid can be introduced into the liquid enclosure; positioning the liquid enclosure in an external container, the external container being sized and shaped to correspond with the size and shape of the liquid enclosure when the liquid enclosure is filled with a beverage; connecting a filling spout to the valve fitment; introducing a desired volume of a beverage into the liquid enclosure through the valve fitment; attaching a source of carbonation to the valve fitment; and introducing pressurized gas into the liquid enclosure through the valve fitment. The carbonization step may cause the liquid enclosure to expand into its filled size and shape, and thereby come into full engagement with the external container.

In one embodiment, the method includes the steps of inserting a first end cap into a first end of the external container and a second end cap into a second end of the external container.

In one embodiment, the method includes the steps of inserting a first resilient foam insert into the space between a first end of the liquid enclosure and the first end cap, and inserting a second resilient foam insert into the space between a second end of the liquid enclosure and the second end cap.

In one embodiment, the valve is a conventional Schrader valve with an integral stem that is manipulated to open and close the valve.

In one embodiment, the method further includes the steps of attaching a dispensing spout to the valve fitment and manipulating the dispensing spout to dispense carbonated beverage from the liquid enclosure. When the valve fitment includes a Schrader valve, the dispensing spout includes a plunger arrangement configured to allow a consumer to selectively manipulate the Schrader valve into an open position to allow dispensing of the carbonated beverage.

In one embodiment, the liquid enclosure collapses as the beverage is dispensed to prevent the development of a headspace within the liquid enclosure. The package may include a supplemental pressure system configured to help maintain the liquid under pressure, which in turn helps to prevent the escape of gas from the beverage when bumped, shaken or otherwise jostled. The supplemental pressure system may be external to the liquid enclosure and may, for example, be in accordance with U.S. Application Ser. No. 63/447,739, entitled PACKAGING SYSTEM FOR CARBONATED BEVERAGES, filed on Feb. 23, 2023, by Green et al., which is incorporated herein by reference in its entirety.

The present invention, in its various aspects, provides several key solutions to past problems that have been observed and modified for better results in the product environment. These past solutions solve specific problems but also create specific issues. Some of the key benefits of different aspects of the present invention are summarized in the following paragraphs.

Structural outer package working with an inner package designed as a system: A first structural shell, a second welded foil fluid storage container, a third pressure valve system wherein, the retaining system expands to contain the fluid system at pressure or retracts to retain the fluid system. For example, packages in accordance with the present invention may be combined with any of the retaining systems and other head space control features set forth in the U.S. Application Ser. No. 63/447,739, entitled PACKAGING SYSTEM FOR CARBONATED BEVERAGES, filed on Feb. 23, 2023, by Green et al. In some applications, the present invention provides a method of carbonating the package post fill. Using foil and exterior package to prevent loss of pressure while protecting the fluid product from gas penetration is beneficial in some applications.

A low-cost high-pressure valve system for dispensing carbonated beverages: Utilizing a Schrader valve and plunger system for dispending pressurized fluids like a simple faucet but at a much lower cost. Past solutions utilized a much larger opening and at much lower pressures. Seals can be the largest failure point for package penetration and pressure loss over time. This proven valve used for a new application creates many new possibilities. When implemented, a simple snap on plunger and sealed assembly creates an ideal faucet for pressurized fluids making a low-cost and simple to produce valve and dispenser.

Head space control: Because the fluid is a positive displacement and the carbonation is post fill the head space can be managed precisely assuring maximum perishable life.

Foil packaging welds designed to end deformed shape: Understanding the deformation of a foil substrate when welded and pressurized and its ability to fit a specific shape allows the liquid enclosure to be implemented with an improved design. The present invention allows designing of the foil and weld system to an end deformed shape that limits stress points or impinging areas that can cause weakness under pressure.

Inner package designed to expand into outer package: By understanding the outer package limits we can design an inner package that is protected by these thresholds and limiting weld stress under pressure. A secondary welded package that is designed to first expand into the side walls and then the end caps. A pressure top and base that allows that deformation, end caps that retain the deformation and foam inserts that can structurally limit the range of expansion.

Handle and plunger storage: The plunger is stored in the plastic top cap, for example, using a small dab of hot melt glue (though the plunger may be secured in other ways). The handles fold down and, if desired, snap into the inside diameter of the top cap enclosing the plunger and valve. The handles and storage may be injection molded and may have a custom snap detail to hold the plunger. The handles and living hinge can be part of the mold draw and slides to provide a strong molded part. The top cap may be glued or ultrasonically welded to the external container. Another feature that may be included in the end caps may be the gusset spacers. These may be molded into or glued to the endcaps.

Valve design: In some embodiments, the present invention provides a valve fitment welded into a liquid enclosure/bag (foil or other) that is designed to dispense fluids under pressure and be adapted to have a snap on plunger and faucet. In some embodiments, the valve fitment may have a valve that can be a closure with threads and a gasket and be adapted to have a snap on dispensing spout with a plunger for actuating the valve.

Storage system for plunger with handles: In some embodiments, the present invention provides a top cap with pop up chipboard or plastic handles for carrying. The handles provide protection and storage for the dispensing spout.

Materials and system for maximizing carbonation and perishable product life: In some embodiments, the present invention provides a low-cost recyclable structural foil system for maintaining pressure and containing a head space control system while also preserving carbonation by limiting expansion while also limiting air exposure to the consumable fluids enhancing shelf life.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A is a top plan view of a package in accordance with an embodiment of the present invention. The first outer package provides a structural element that limits the expansion of the inner package from expanding beyond it's designed criteria. The valve allows the fluid to be removed while under pressure and also allows the fluid to be pressurized. In this embodiment the foil bag has a standup gusset that is designed to fit the inner space of the out enclosure. Like the shown embodiment of the outer enclosure foil bag is also shipped flat or knocked down for ease of shipping and handling. The valve fitment snaps through a hold and positions the bag for initial filling. Top and bottom caps along with associated features are shown below.

FIG. 1B is a bottom plan view of a package in accordance with an embodiment of the present invention.

FIG. 1C is a partially exploded bottom view of the package with the bottom end cap removed.

FIG. 1D is an image of a standup gusset in the end of a liquid enclosure.

FIG. 2A is a representational view of the package of FIG. 1 showing certain hidden parts.

FIG. 2B is a bottom view of the package of FIG. 1.

FIG. 3 is a partially exploded sectional view of the valve fitment, valve and dispensing spout with valve plunger.

FIG. 4A is a representational view of a first alternative package.

FIG. 4B is a bottom view of the first alternative package.

FIG. 4C is a perspective view of a segment of a conventional shipping tube fitted with a conventional end cap.

FIG. 5A is a side image of an expanded foil bag in accordance with the prior art.

FIG. 5B is a front image of an expanded foil bag in accordance with the prior art.

FIG. 6A is a representational view of a flat foil bag in accordance with the prior art.

FIG. 6B is a representational view showing a liquid enclosure in accordance with an embodiment of the present invention.

FIG. 6C is a representational view showing an alternative liquid enclosure in accordance with an embodiment of the present invention.

FIG. 7 is a representational view showing another alternative liquid enclosure in accordance with an embodiment of the present invention.

FIG. 8A is a representational view of a second alternative package with the end caps removed.

FIG. 8B is a representational view of the external container of the second alternative package in a flat condition.

FIG. 8C is an enlarge portion of the external container showing a lap seam joined by glue.

FIG. 9A is a bottom plan view of an end cap with a peripheral lip.

FIG. 9B is a side view of the end cap of FIG. 9A.

FIG. 9C is a bottom plan view of an end cap with a peripheral track.

FIG. 9D is a side view of the end cap of FIG. 9C.

FIG. 9E is a top plan view of a top end cap with integrated handles.

FIG. 9F is a side view of the end cap of FIG. 9E.

FIG. 9G is a top plan view of a structural spacer.

FIG. 9H is a side view the structural spacer of FIG. 9G.

FIG. 10A is a representational top view of a pair of foam inserts with a line representing the profile of the external container.

FIG. 10B is a side view of the foam inserts.

FIG. 11 is a flow chart showing a method in accordance with an embodiment of the present invention.

### DETAILED DESCRIPTION OF THE CURRENT EMBODIMENTS

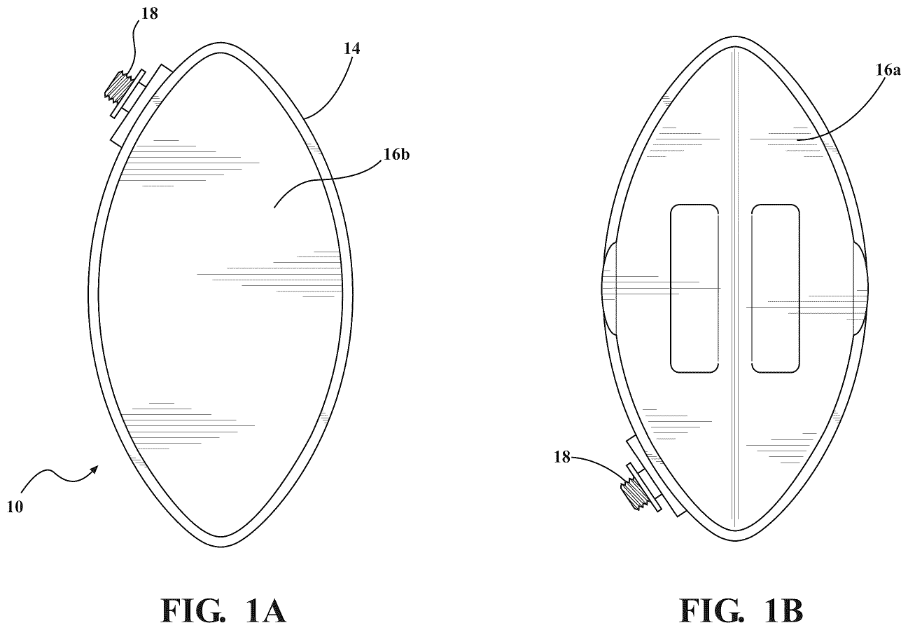

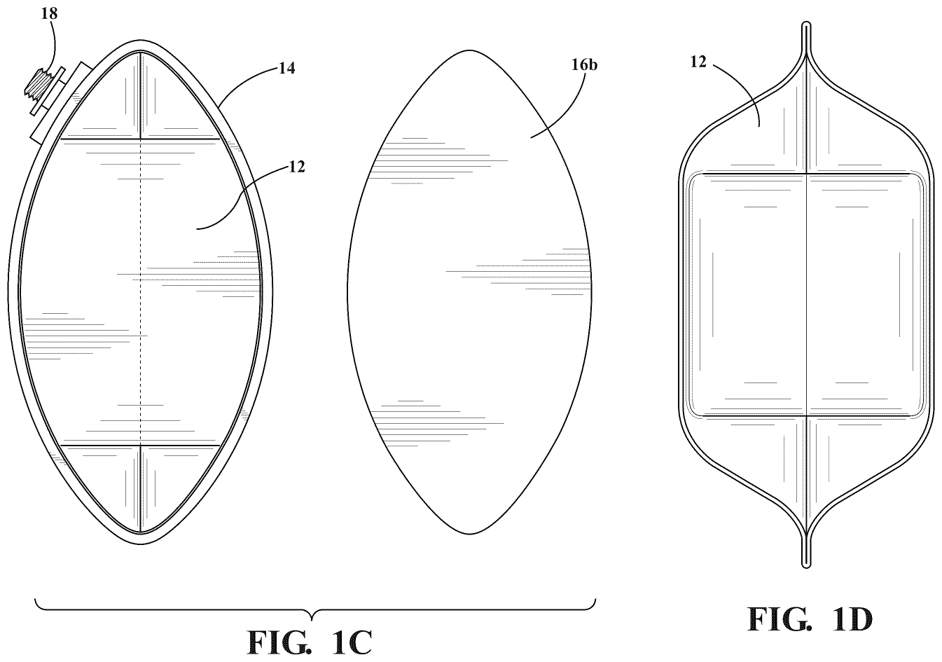

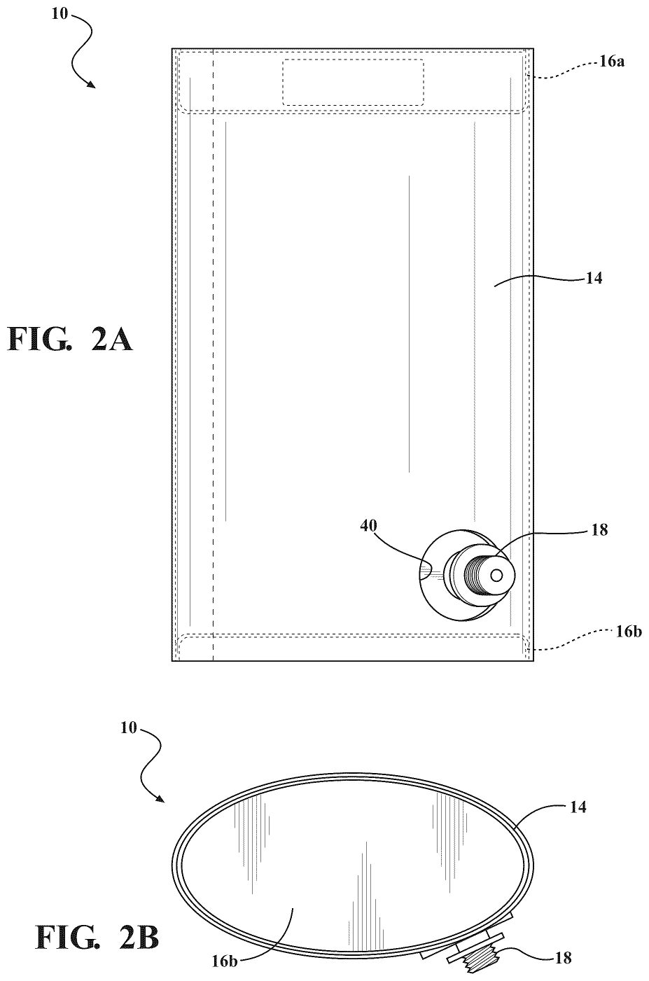

A current embodiment of a multi-material package for carbonated beverages is shown in FIGS. 1A-2B. In the illustrated embodiment, the package 10 generally includes an internal liquid enclosure 12 disposed within an external container 14 in which the size and shape of the liquid enclosure 12 and the external container 14 are coordinated so that the external container 14 provides supplemental support to the liquid enclosure 12 when the liquid enclosure 12 reaches its maximum size. In this embodiment, the internal liquid enclosure 12 is a foil bag with welded seams that is provided in a flat, empty state and expands as it is filled with liquid. The liquid enclosure 12 reaches a maximum size and shape when it is filled with the desired volume of carbonated beverage. In the illustrated embodiment, the external container 14 is a cardboard or paperboard container with top and bottom ends that are closed by end caps 16. The external container 14 defines an internal space that generally corresponds in size and shape with the liquid enclosure 12 when the liquid enclosure 12 is full. As such, the liquid enclosure 12 and the external container 14 cooperate to contain the pressure within the liquid enclosure 12. The package 10 includes a valve fitment 18 that is sealingly installed in the liquid enclosure 12. The valve fitment 18 is accessible through an opening defined in the external container 14 so that the liquid enclosure 12 can be filled and emptied through the valve fitment 18 even when the liquid enclosure 12 is housed in the external container 14. In the illustrated embodiment, the valve fitment 18 seats a generally conventional Schrader valve that is configured to withstand the maximum internal pressures within the filled package 10. The package 10 also includes a removable dispensing spout 20 that can be selectively attached to valve fitment 18 to allow a consumer to manipulate the valve to dispense the carbonated beverage.

To provide an economical package, the external container 14 may be formed from a segment of conventional cardboard or paperboard tube. The ends of the tube may be closed by conventional cardboard/paperboard tube end caps 16a-b, such as molded plastic end caps configured to be fitted into the ends of the cardboard or paperboard tube. The end caps 16a-b are positioned to receive and support opposite ends of the liquid enclosure 12 when the liquid enclosure 12 has reached its filled size and shape. The end caps 16 are secured in place as needed to withstand the anticipated internal pressure of the liquid enclosure 12. In some applications, the end caps 16 may be frictionally fitted into the tube ends and held only by the frictional interface. In other applications, the end caps may be affixed to the tube, for example, by fasteners or adhesive. In still other applications, the end caps may be held in place by portions of the tube that are folded into the interior of the tube to retain the end caps.

As noted above, the package 10 generally includes an internal liquid enclosure 12 and an external container 14. The internal liquid enclosure 12 is manufactured from a flexible film material that is suitable for retaining carbonated beverages. In the illustrate embodiment, the liquid enclosure 12 is a foil bag formed from welded sheets of flexible film material (See, for example, FIG. 1C). As shown, the liquid enclosure 12 is formed from a front sheet, a rear sheet, a top sheet and a bottom sheet that are joined using convention techniques and apparatus. For example, in the illustrated embodiment, the peripheral edges of adjacent sheets are joined by welding and/or adhesive. The sheets that form the top and bottom ends of the liquid enclosure 12 are joined to the front and rear sheets by welding and/or adhesive, and are configured to implement a standup gusset. An exemplary standup gusset is shown in FIG. 1D. The standup gusset arrangement provides the liquid enclosure with relatively broad and flat ends with wide welds and the dome-like structure gives an enhanced ability to respond to surges in internal pressure within the liquid enclosure. Beneficially, the standup gussets at the top and bottom ends of the liquid enclosure 12 are relatively flat and provide a relatively high degree of uniform contact with the end caps 16, which in turn provides relatively uniform pressure distribution over the end caps 16 when the liquid enclosure 12 is full. Although the liquid enclosure 12 of the illustrated embodiment includes standup gussets at the top and bottom ends, the top and bottom ends of the enclosure 12 may be closed using other end configurations, including other types of gusset or folds.

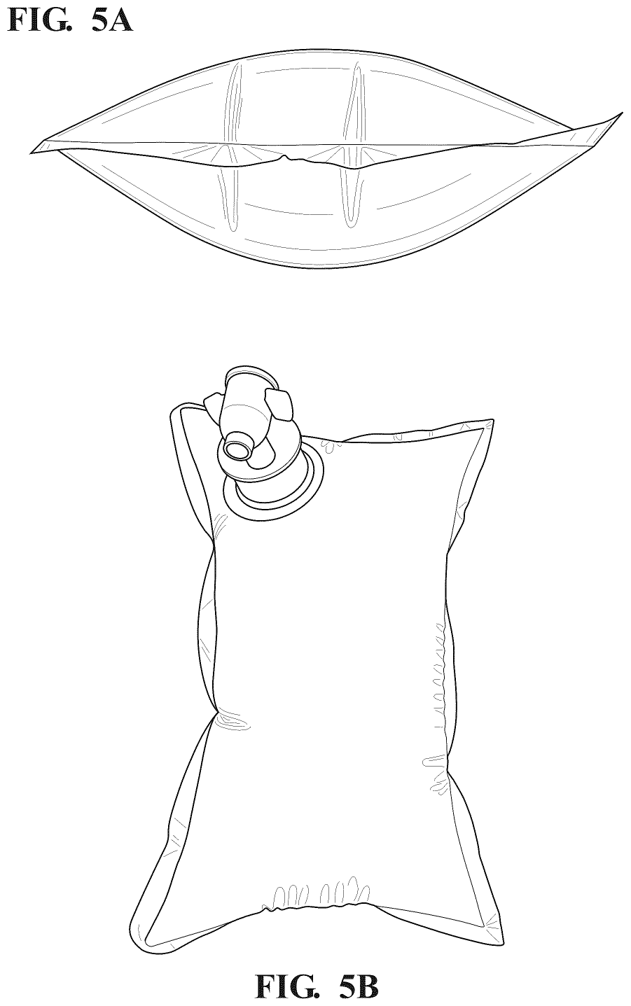

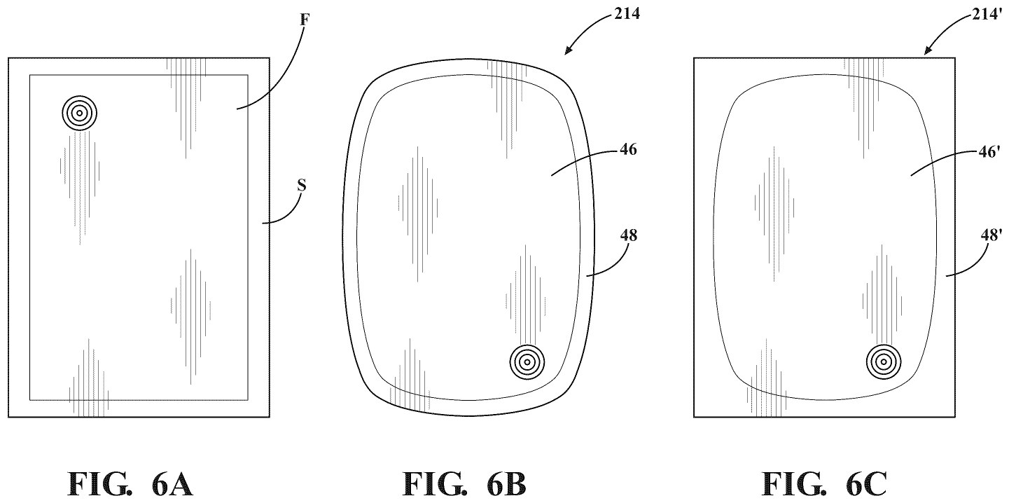

In the illustrated embodiment, the liquid enclosure 12 is manufactured from a laminated sheet material that includes one or more foil layers and one or more plastic layers. In some applications, the laminated sheet material may include one or more layers of aluminum foil or other metalized film, and one or more layers of polyester and/or polyethylene. The various layers of foil and plastic may be laminated together in a wide variety of alternative configurations. For example, the liquid enclosure 12 may be manufactured from any of a wide range of films suitable for storing beverages, such as ePac Flexables and other films that include foil and are suitable for retaining. When combined with the structural outer enclosure these foil structures can be pressurized. When desired, the films used to form the bags 14 and 16 may include specialized additives or be coated to enhance functionality, such as minimizing the escape of gas, minimizing oxygen penetration and reducing UV light penetration. Although the illustrated liquid enclosure 12 includes a bag formed from separate panels that are welded or otherwise joined, the present invention may be implemented with a seamless bag. A variety of bags suitable for use as a liquid enclosure are commercially available from a variety of different suppliers. By way of example, a wide range of bags suitable for use in connection with the present invention are available from Rapak (see, e.g., www.rapak.com). Seamless liquid enclosures may, in some applications, be blow-molded. Further, although the liquid enclosures of FIGS. 6B and 6C each include two panels of sheet stock (e.g. front and rear panels) that joined together at peripheral seams and the embodiment of FIGS. 1-3 and 7 includes four panels of sheet stock (e.g. front, rear, top and bottom panels) that are joined together at the illustrated seams, the liquid enclosure may be configured from a different number of panels and a different number of welded or adhesive closures. For example, the liquid enclosure may be formed from as few as a single sheet that is folded, perhaps origami style, to form the desired shape. The folded single sheet of may be closed by or more welded or adhesive closures.

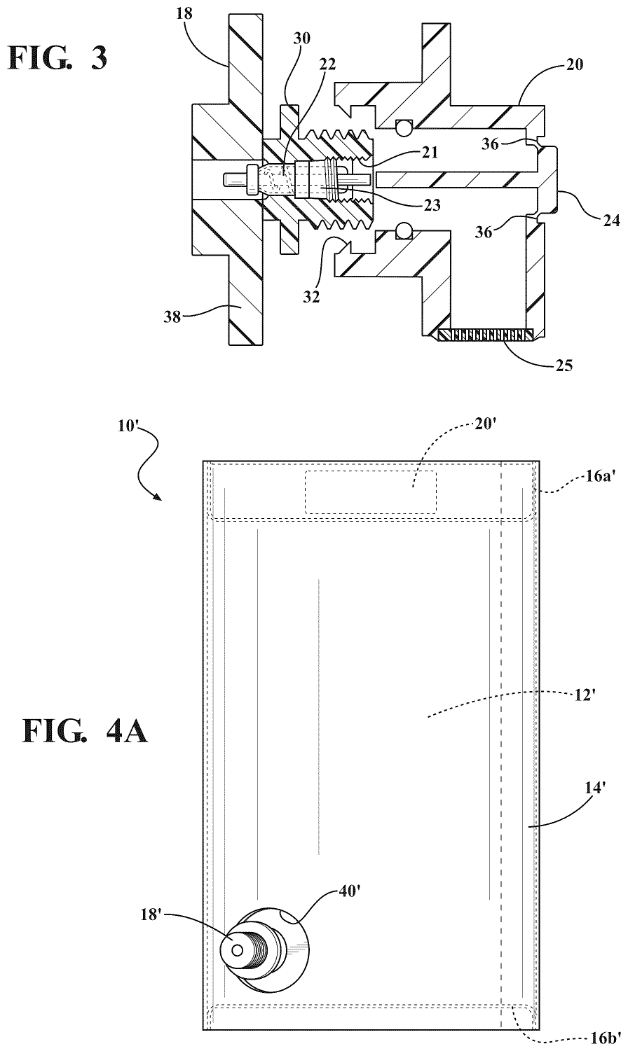

The liquid enclosure 12 of the illustrated embodiment includes a valve fitment 18 that provides valve-controlled access to the interior of the liquid enclosure 12 (See FIGS. 1 and 3). The valve fitment 18 is fitted into an opening defined in the liquid enclosure 12 and joined to the liquid enclosure 12 with a leaktight seal between the liquid enclosure 12 and the valve fitment 18. The valve fitment 18 is affixed to the liquid bag 14 using conventional techniques and apparatus. For example, the valve fitment 18 may include a peripheral flange or shoulder 38 that is joined to the liquid enclosure 12 using adhesives, fusion, compression or essentially any other leaktight connection. In this embodiment, the valve fitment 18 defines a through-hole that provides a passage from the interior to the exterior of the liquid enclosure 12 through which the liquid enclosure 12 can be filled and emptied. As shown, the valve fitment 18 of the illustrated embodiment is integrated into the liquid enclosure 12 and extends outwardly through an opening in the external container 14 where it is accessible from the exterior of the package 10. In other applications, the valve fitment 18 may be flush with or recessed into the periphery of the external container 14.

Referring now to FIG. 3, the valve fitment 18 is configured to seat a valve 22 in the through-hole to selectively open and close the passage. The valve provides a leaktight seal capable of retaining the anticipated internal pressures within the liquid enclosure 12. In the illustrated embodiment, the valve fitment 18 is configured to seat a valve 22 that is biased in the closed position to withstand internal pressures, but is capable of being selectively opened to permit filling and dispensing. In the illustrated embodiment, the valve is a conventional Schrader valve and the valve fitment 18 includes a conventional internally threaded seat that is configured to threadedly receive a conventional externally threaded Schrader valve. The Schrader valve is situated in the valve fitment 18 so that the valve stem can be manipulated from the exterior of the liquid enclosure 12. For example, the Schrader valve may be threaded into the valve fitment 18 while the liquid enclosure 12 is flat and before it is filled.

To facilitate dispensing of the carbonated beverage, the package 10 of the illustrated embodiment is provided with a dispensing spout 20 configured to mount to the valve fitment 18 and operatively interact with the valve 22. In the illustrated embodiment, the dispensing spout 20 is provided separated from the valve fitment 18 and is configured to be attached by the consumer. For example, the dispensing spout 20 may be bundled with the package 10 and may be configured to be installed on the valve fitment 18 in operative engagement with the valve 22. Providing the dispensing spout 20 separate from the package 10, reduces the overall size of the package 10, thereby facilitating shipping and storage. In use, the dispensing spout 20 is manually installed on the valve fitment 18 and is configured to provide a mechanism for opening and closing the valve 22. As discussed above, the valve 22 of the illustrated embodiment is a generally conventional Schrader valve with a valve stem that is manipulated in a known manner to open the valve 22. The illustrated dispensing spout 20 includes a plunger 24 that can be manipulated by a consumer to actuate the valve stem and open the valve 22. The dispensing spout 20 may be connected to the valve fitment 18 using any desired attachment structure. For example, the dispensing spout may include threads, a quarter-turn fitting, a snap-fitting or essentially any other attachment mechanism capable of situation the dispensing spout 20 over the valve fitment 18 with the plunger 24 in appropriate alignment with the valve stem of the Schrader valve. FIG. 3 is a sectional view showing the dispensing spout 20 disposed adjacent to the valve fitment 18. The sectional view shows the Schrader valve 22 threadedly installed in the valve seat. The valve fitment 18 includes a locking ring 30 and the dispensing spout 20 includes a detent lock 32 that selectively interlocks with the locking ring 30 to secure the dispensing spout 20 on the valve fitment 18. In the illustrated embodiment, a seal 31 is also provided to form a leaktight interface between the dispensing spout 20 and the valve fitment 18. The seal 31 may, for example, be an o-ring seal. In some embodiments, a seal may not be included, such as when the connection structure is sufficiently leaktight so as to prevent leaking through the interface between the dispensing spout 20 and the valve fitment 18. The plunger 24 is shown mounted in the dispensing spout 20 in alignment with the valve stem 23 of the Schrader valve. In this embodiment, the dispensing spout 20 is molded and the plunger 24 is molded as an integral part of the dispensing spout 20 with a living hinge 36 that allows the button end of the plunger 24 to be manipulated by an end user to displace the valve stem and dispense the contents of the package 10. The living hinge 36 may, for example, be a thinned portion of material that is thin enough to flex and allow the plunger 24 to be manipulated as needed to displace the valve stem 23 of the Schrader valve. In the illustrated embodiment, a screen 25 is disposed in or over the dispensing opening of the dispensing spout 20. For example, a plastic screen 25 is heat welded to the dispensing spout 20. Further, the dispensing spout 20 can be formed with an integrated grip to facilitate installing and removing the dispensing spout 20 on the valve fitment 18. The screen FIG. 3 also shows the valve fitment with a peripheral flange 38 that is sealed (e.g. by welding and/or adhesives) to the liquid enclosure 12.

While the package 10 is typically provided with a separated dispensing spout 20, the package 10 may in some embodiments be provided with the dispensing spout 20 already installed. A custom valve and plunger design was required to handle the pressures and opportunities for oxygen penetration to the fluid.

As noted above, the liquid enclosure 12 is disposed within the external container 14. Unlike conventional packaging solutions, the liquid enclosure 12 and the external container 14 are coordinated in size and shape so that the liquid enclosure 12 and the external container 14 cooperate to withstand the internal pressure of the liquid enclosure when the package 10 is filled. More specifically, the size and shape of the liquid enclosure 12 and the external container 14 are coordinated so that as the liquid enclosure 12 expands into its filled size and shape, it expands into firm contact with the surrounding external container 12 with the liquid enclosure 12 and the external container 12 both supporting a portion of the internal pressure in the liquid enclosure 12.

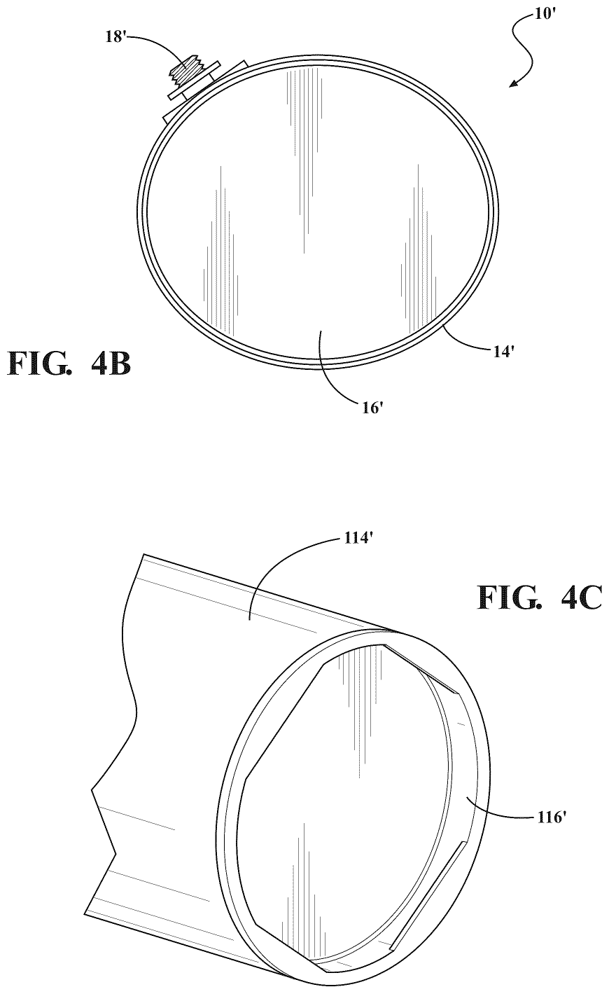

The external container 14 may be formed by folding and gluing cardboard, paperboard, corrugated plastic or other similar materials into a size and shape that corresponds with the size and shape of the liquid enclosure 12. The external container 14 may, for example, be die cut from cardboard or paperboard sheet stock using conventional techniques and apparatus. If manufactured from cardboard or paperboard, the stock material may be coated as desired. For example, the external container 14 may include a laminated coating that provides the desired graphics and information. If desired, a polyurethane coating, clear acrylic paint or lacquer spray can be applied to the cardboard to make it weatherproof or weather resistant, which may help to protect the external container 14 when it comes into contact with the packaged beverage. In some applications, the external container 14 may be manufactured from other types of materials, such a plastic film or corrugated plastic. The size, shape, strength and durability of the external container 14 may vary from application to application, as desired. For example, heavier cardboard stock may be used when packaging greater volumes of carbonated beverage or when the internal pressure of the filled liquid enclosure 12 is greater. In the embodiment of FIGS. 1-2, the external container 14 is a cardboard or paperboard sleeve formed from a generally conventional die-cut cardboard blank. The ends of the sleeve are open and are configured to receive end caps 16. The valve hole 40 may be formed as an integral part of the die cutting step. In alternative embodiments (such as shown in FIGS. 4A and 4B), the external container 14 is manufactured from a segment of conventional cardboard or paperboard tube. A wide variety of cardboard/paperboard tubes suitable for use in forming the external container 14 are readily available from well-known suppliers.

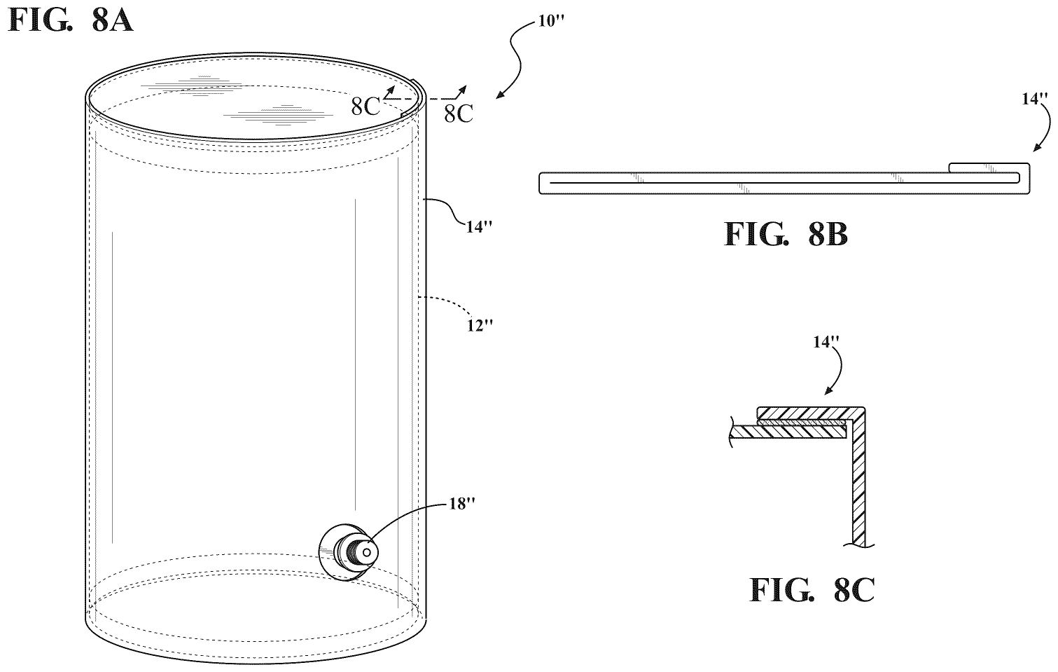

In the illustrated embodiment, the external container 14 is generally configured as a sleeve with open top and bottom ends. For example, as shown in FIG. 1A, the external container 14 of the illustrated embodiment is formed by wrapping a sheet of stock material into the desired shape and joining opposed free edges, typically by cement/adhesives. As shown, the external container 14 has a somewhat elongated oval cross-sectional shape that corresponds with the external shape of the liquid enclosure 12. The external container 14 also corresponds in size with the liquid enclosure 12 to provide cooperative support against internal pressures within the liquid enclosure 12 as discussed in more detail elsewhere herein. In alternative applications, the size and shape of the external container 14 may vary to correspond with the external size and shape of the filled liquid enclosure 12. For example, as shown in FIGS. 4B and 8A, the external container may be circular in cross-section when intended for use with a liquid enclosure that has a generally circular external surface.

In the illustrated embodiment, opposite open ends of the external container 14 are closed in such a way as to interface with and support the top and bottom ends of the filled liquid enclosure 12. Referring now to FIGS. 1B and 2, the top and bottom ends of the external container 14 are closed by end caps 16a-b. In the illustrated embodiment, the end caps 16a-b are fitted into the top and bottom ends of the external container 14 and positioned to engage with the top and bottom ends of the liquid enclosure 14 when the liquid enclosure 14 is filled. The illustrated end caps 16a-b may be manufactured from essentially any material capable of withstanding the anticipated pressures. For example, the end caps 16a-b may be plastic or molded paper/paperboard. When plastic, the end caps 16a-b may be injection molded from an appropriate plastic to the desired size and shape. When paper/paperboard, the end caps 16a-b may be die cut and stamped into the desired size and shape. For example, a sheet of flat paper/paperboard may be formed about a mandrel to produce a circumferential wall that interfaces with the interior surface of the external container 14. In the embodiment of FIGS. 1-2, the ends caps 16a-b may be custom formed to match with the cross-sectional shape of the external container 14.

As shown in FIGS. 1-2, each of the end caps 16a-b may be configured to fit entirely within the external container 14. In this embodiment, each end cap 16a-b includes a planar central body 42 and a short circumferential wall 44 extending from the central body 42. The outer dimensions of the circumferential wall 44 are selected to be roughly equal to the inner dimensions of the external container 14 with the precise dimensions of both being selected to set the amount of force required to move the end caps 16a-b within the external container 14. For example, the outer dimensions of the end caps 16a-b may be slightly greater than the inner dimensions of the external container 14 to provide a tight interference fit (or press fit) between the end caps 16a-b and the external container 14. In other applications, the end caps and external container may be dimensioned to provide a clearance fit. To resist removal, the engagement surfaces of the end caps 16a-b may have one or more external protrusions that bind against the external container 14. For example, one or more annular protrusions may extend around all of a portion of the end caps 16a-b to end engage with the external container 14. In some embodiments, the end caps 16a-b may include a plurality of annular protrusions that are angled to facilitate insertion and resist removal of the end caps 16a-b from the open ends of the external container 14. In addition, or as an alternative, the end caps 16 may be glued and/or stapled in place for strength. In some alternative embodiment, the external container 14 may include integral tabs (not shown) that are folded down into the open ends of the external container 14 after the end caps 16a-b have been inserted. The end caps may be secured in place by any one or more of these alternative attachment methods, or by other attachment mechanisms.

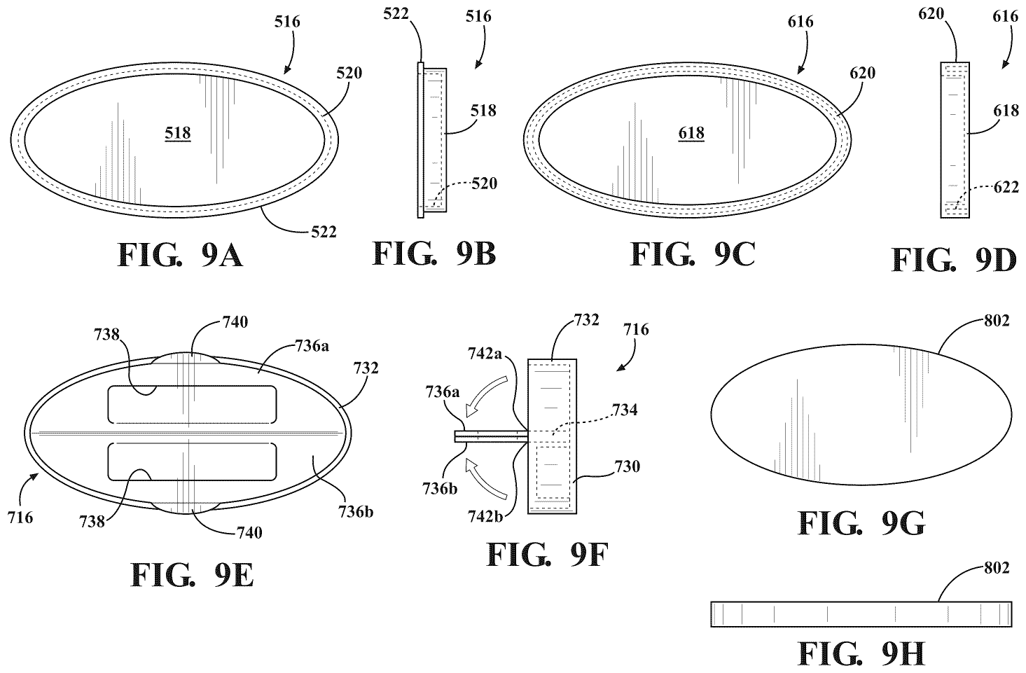

FIGS. 1B and 2A show the package 10 with different top end caps. In FIG. 1B, the top end cap 16a includes an integral handle that is formed from two handle portions that are movable between a collapsed position in which they close the top of the end cap and a raised position in which they fold up adjacent to one another to in combination form a handle. This embodiment of the end cap is discussed in more detail below in connection with FIGS. 9E and 9F. In the embodiment, the top end cap 16a does not incorporate the handle, but it does have sufficient depth to store the dispensing spout 20. For example, the dispensing spout 20 may be placed in the top end cap 16a during manufacture where it is easily accessible to the end user. The dispensing spout 20 may be loosely placed in the top end cap 16a and retained by some form of outer packaging, such as a film that closes the top of the package 10 or closes the top of the top end cap 16a. Alternatively, the dispensing spout 20 may be fitted into a seat formed in the top end cap 16a or be glued, taped or otherwise temporarily fixed in place. In one application, the dispensing spout 20 may be secured in place by hot melt glue or a similar adhesive.

In alternative embodiments, the end caps may be configured to be movable during use. For example, the package may be configured so that one or both of the end caps are capable of being pushed progressively farther into the external container 14 as the liquid enclosure 12 is emptied. The end cap(s) may be configured to facilitate inward movement, but resist outward movement relative to the external container 14. For example, the periphery of the end cap(s) may include one or more protrusions that provide greater resistance to outward movement. The one or more protrusions may be triangular in cross section with an angle surface facing inwardly and a perpendicular surface facing outwardly, thereby facilitating one-way inward movement of the end cap(s) 16. As another example, the one or more protrusions may be flexible fins that are angled outwardly or bend outwardly as the end cap is inserted. The fins provide limited resistance to inward movement, but provide significant resistance to outward movement. In other embodiments, the external container 14 may include features, such as ramp-like embossing, debossing or inserts that help to facilitate one-way inward motion of the end cap(s). In embodiments with movable end caps, the end user can use the push-in end cap(s) to help push the contents of the liquid enclosure 12 from the package 10. The push-in end cap(s) can additionally or alternatively be pressed into firm contact with the liquid enclosure 12 after dispensing to help maintain pressure on the packaged carbonated beverage even as the package 10 is emptied. In some embodiments, the bottom end cap may be fixed to the external container 14 so that it does not move, and the top end cap may be movable so that an end user can push down on the top end cap. This approach may be beneficial when the dispensing spout 16 is disposed toward the bottom of the package 10 and there is not much room to move the bottom end cap inwardly without interfering with dispensing.

In alternative embodiments, the end caps may be configured to engage with the top and bottom ends of the external container. This configuration can among other things help to ensure precise placement of the end caps relative to the free ends of the external container. For example, FIGS. 9A and 9B show an alternative end cap 516 configured to abut with the free ends of the external container. In this embodiment, the end cap 516 includes a planar central body 518 with a circumferential wall 520 that terminates in a narrow peripheral lip 522. The central body 518 and circumferential wall 520 are configured to be fitted into the external container 14 and the peripheral lip 522 is configured to abut the edge of the external container 14.

In another alternative embodiment shown in FIGS. 9C and 9D, the end cap 616 is configured to entrap the end of the external container to provide enhanced support. In this embodiment, the end cap 616 generally include a planar central body 618 and a circumferential track 620 that extends around the periphery of the central body 618. The track 620 defines a narrow channel 622 configured to receive the free end of the external container and resist inward and outward deformation of the end of the external container.

As noted above, the liquid enclosure 12 and the external container 14 are designed in concert so that they cooperate to withstand the internal pressure of the filled liquid enclosure 14. In typical implementations, when the package 10 is filled with carbonated beverage, the internal pressure of the carbonated beverage will be sufficient to expand the liquid enclosure 12 to its full size and shape to such a degree that there will be some pressure on the seams of the liquid enclosure 12, while at the same time the liquid enclosure 12 will have expanded into contact with the external container 14 such that the external container 14 functions as a supplement to bear some, but not all, of the internal pressure in the liquid enclosure 12. In the illustrated embodiment, the size and shape of the liquid enclosure and the external container are designed to cooperatively withstand the anticipated internal pressures generated by the packaged carbonated beverage through a range of customary environmental conditions to which the package might be subjected, such as bumping, jostling, variations in atmospheric pressure, variations in temperature, variations in altitude and essentially any other factors that might affect the integrity of the package. In typical applications, increasing the amount of surface area of the liquid enclosure 12 that is engaged with the external container 14 increases the degree to which the liquid enclosure 12 and external container 14 are cooperating in containing the internal pressures. In some embodiments, approximately 95 to 99% of the surface areas of the liquid enclosure 12 is engaged with the exterior container 14. In other applications, approximately 65 to 75% or 65 to 80% of the surface areas of the liquid enclosure 12 is engaged with the exterior container 14.

FIGS. 4A-C show an alternative embodiment in which the package 10′ is generally cylindrical. The package 10′ is generally identical to package 10, except as described herein and shown in the associated figures. In this embodiment, the liquid enclosure 12′ is configured to expand into a generally cylindrical shape when filled, and the external container 14′ is a cylindrical tube sized and shaped to provide supplemental support to the liquid enclosure 12′ when it is filled. In this application, the external container 14′ may be formed from a segment of conventional cardboard or paperboard shipping tube, which is inexpensive and readily available from a wide variety of suppliers. As an alternative to use of off-the-shelf cardboard/paperboard tube, the external container may be custom-formed specific for the application.

In the embodiment of FIGS. 4A and 4B, the top and bottom ends of the external container (i.e., the tube) 14′ are closed by circular end caps 16a-b′. In the illustrated embodiment, the top and bottom end caps 16a-b′ are configured to fit completely inside the external container 14′. However, FIG. 4C shows an alternative embodiment in which an end cap 116′ is configured to abut the end of the tube 114′. The end cap 116′ of FIG. 4C may be a conventional end cap of the type sold for use in closing the ends of conventional cardboard/paperboard shipping tubes. End caps of this type are available from a wide variety of suppliers.

FIGS. 5-7 illustrate another aspect of the present invention. Conventional seamed bags are formed by joining two sheets of stock material along their peripheral edges, for example, by welding and/or adhesives. It has been determined that this approach results in a bag that deforms into a somewhat irregular shape as it pillows outwardly when filled. As shown in FIGS. 5A and 5B, the seamed edges of a filled seamed bag bow inwardly and develop a number of wrinkles and deep creases that interfere with the ability of external container to provide supplemental support for the enclosed seamed bag. More specifically, when the seamed bag is filled, the central portions of the inwardly bowed edges are less likely to interface with the external container and may be left without direct supplemental support from the external container. Further, the deep creases formed along the seams will not only fail to engage with the external container, but will also create high tension regions where the seamed bag may be more likely to fail.

To address these and potentially other issues associated with conventional seamed bag constructions, the present invention provides a liquid enclosure that is formed from sheet stock in which the profile of the sheets is configured to correspond with the size and shape of the filled bag. FIG. 6A is a representational view of a conventional seamed bag in which two layers of rectangular laminated film F are laid one upon the other and then sealed together by a rectangular seam S extending around the periphery. When filled, seamed bags with this configuration will expand into the deformed state shown in FIGS. 5A and 5B and suffer from the issues discussed above. FIG. 6B is a representational view of a liquid enclosure 214 in accordance with an aspect of the present invention. As with conventional seamed bags, the liquid enclosure 214 of FIG. 5B is formed from two layers of the desired laminated film 46 that are joined around their periphery by a seam 48. However, in this embodiment, the peripheral edges of the sheets of film are curved as a function of the size variations of the filled bag to reduce the tendency for the edges to bow, wrinkle and form creases with the bag is filled. For example, the curved profile of the edges of the sheet stock, including the top, bottom, left and right edges, may be curved to correspond with the amount of pillowing that will occur when the bag is filled. In addition or as an alternative to varying the shape of the sheet stock, the size and shape of the seams may be varied to provide the filled seamed bag a generally smooth and uniform outer surface. For example, as shown in FIG. 6C, the film sheets 46′ may have a rectangular periphery, but the seams 48′ may be shaped to provide essentially the same functionality as the embodiment shown in FIG. 6B. It should be noted that the seam 48′ need not run complete to the outer peripheral edge but may stop short as represented by the broken line in FIG. 6B.

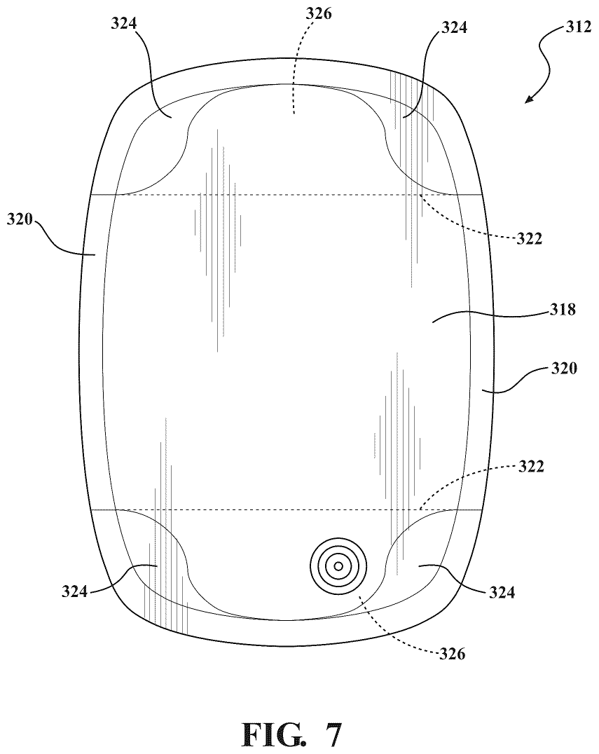

In applications in which one or more ends of the liquid enclosure are closed by a standup gusset or other type of gusset/fold, the profile of the sheet stock can be selected to correspond with the filled shape of the gusset or fold. This may, for example, involve variations to the shape of the top and bottom peripheral edges of the front and rear sheets and to the peripheral edges of the sheets that form the gussets or folds. It may additionally or alternatively involve variations in the size and shape of the seams. For example, FIG. 7 is a representational view of the liquid enclosure 312 with top and bottom standup gussets. The front and rear of the liquid enclosure 312 are formed by front and rear sheets 318 that are joined along the sides by seams 320. In this embodiment, the gussets are formed by additional panels 326 that are installed in the top and bottom ends of the liquid enclosure 312. Each gusset panel 326 is folded along line 322 into front and rear segments, and the front and rear segments are joined to the front and rear sheets 318 along welded seams 324. Standup gussets are well-known and therefore will not be described in detail. Suffice it to say that the peripheral shape of the gusset panels and the size, shape and configuration of the seams may be configured to prevent or reduce deformation when the liquid enclosure is filled. The weld shape is tailored to fit the inside of the external container when the liquid enclosure is filled. Prototype builds and computer models enable multiple weld and shape configuration to be tested for the best fit and strength.

FIGS. 8A-C show an alternative embodiment in which the package 10″ is generally cylindrical, but unlike the embodiment of FIGS. 4A-C includes an external container 14″ that is capable of being folded flat for storage. In this embodiment, the package 10″ is generally identical to package 10′, except as described herein and shown in FIGS. 8A-C. In this embodiment, the liquid enclosure 12″ is configured to expand into a generally cylindrical shape when filled, and the external container 14″ is essentially a flat sleeve. In this embodiment, the external container 14″ may be formed from a rectangular blank of the desired sheet stock that is folded onto itself and glued along a lap seam. The external container 14″ may, for example, be formed from paperboard sheets, corrugated paperboard sheets, cardboard sheets, plastic sheets or corrugated plastic sheets. In other embodiments, the knock down external container 14″ may be pre-molded. For example, it may have details for ultrasonic welding or gluing of the end caps, such as embossing, debossing, folds and/or cutouts. For example, FIG. 8C shows the external container 14″ knocked down (e.g. flat) before insertion of the liquid enclosure 12″. FIG. 8B is an enlarged representational view of a portion of the external container 14″ showing the lap seam and one of the folds along which the external container 14″ can be knocked down into a flat configuration. In this embodiment, the top and bottom ends of the external container 14″ are closed by circular end caps (not shown). The top and bottom end caps may be manufactured from a wide range of materials, such as paperboard, cardboard and plastic. As with other embodiment, an opening is formed in the external container 14″ to allow the valve fitment 18′ to protrude from the liquid enclosure 12′.

In an alternative embodiment shown in FIGS. 9E and 9F, the top end cap 716 may include an integrated handle structure that helps a consumer lift and carry the package and/or pour contents from the package. The top end cap 716 of the illustrated embodiment includes two handle portions that can be folded flat when not in use to reduce the profile of the package for shipping and storage. In other alternative embodiments, the top end cap may include a single handle that that can be folded up and down as desired. The top end cap 716 with integrated handle can be manufactured using any suitable techniques and apparatus. For example, the top end cap 716 may be formed from cardboard or paperboard using conventional cutting, folding and shaping operations. In the illustrated embodiment, the top end cap 716 is manufactured from plastic and is injection molded using conventional molding apparatus. The top end cap 716 may be molded in the state shown in FIG. 9E. The top end cap 716 of this embodiment includes a central body 730 with a peripheral wall 732. The handle is formed from two separate handle portions 736a and 736b that are joined to upright 734 by integrated living hinges 742a and 742b. The living hinges 742a and 742b facilitate folding movement of the handles. Openings 738 are defined in each handle portion 736a and 736b to provide the handle with a finger slot. The openings may be formed during molding or may be formed in a subsequent operation. Additionally, each handle portion 736a and 736b may have a tab 740 that abuts the peripheral wall 732 when the handle portions 736a-b are folded flat. The tabs 740 may be configured to snap-lock or otherwise interfit with the peripheral wall 732 to selectively hold the handle portions 736a-b in the folded state. Although not shown, the handle portions 736a-b may include features that allow them to snap together to them hold them together in the raised position. In embodiments that include a separate dispensing spout 720, the dispensing spout 720 may be enclosed in the top end cap 716 under one of the fold-down handle portions (See FIG. 9F).

As noted above, the end caps may be manufactured from a wide range of alternative materials, such as paperboard, cardboard and various types of plastic. In applications in which an end cap is manufactured from a material that does not have sufficient rigidity to remain relatively flat when subjected to pressure from the filled liquid enclosure, the package may include a structural spacer. For example, FIGS. 9G and 9H show a structural spacer 802 that is configured to be inserted into the external container 14 before the end cap 16 where it will provide a rigid interface between the liquid enclosure 12 and the end cap 16. The illustrated structural spacer 802 is shaped to correspond with the cross-sectional shape of the external container 14 and the main body portion of the end cap 16. To provide a relatively inexpensive insert, the structural spacer 802 may be manufactured from a paperboard, cardboard or plastic and have a honeycomb, corrugated or structural laminate configuration. When a structural spacer 802 is used under an end cap 16, the position of the end cap 16 within the external container 14 will be selected to accommodate the structural spacer 80. More specifically, the end cap 16 will be positioned so that the end of the liquid enclosure 12 will engage the structural spacer 802 and end cap 16 such that the liquid enclosure 12 and the end cap 16 are cooperatively supporting the internal pressure of the filled liquid enclosure 12.

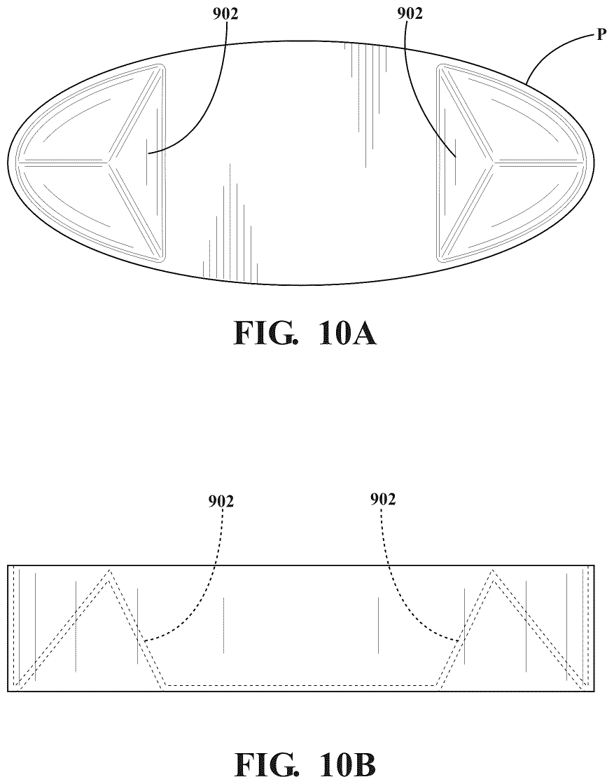

As noted above, one aspect of the present invention is to provide a package 10 in which the liquid enclosure 12 and the external container 14 cooperatively support the internal pressure of the filled liquid enclosure 12. This approach reduces the structural requirements that would be applicable if the liquid enclosure or the external container was required to withstand the internal pressure on its own. Typically, the ability of the liquid enclosure and external container to cooperate in supporting the internal pressure is enhance by increasing the degree to which the external surface of the liquid enclosure is in direct contact with the external container 14 and the end caps 16. In embodiments in which the ends of the liquid enclosure include gussets or other folds, it may be difficult to design an end cap that will engage with the outer surface of the liquid enclosure throughout the gusset or fold region. As a result, these regions of the liquid enclosure may not receive direct external support from the end caps. To address this issue, a foam insert configured to correspond is size and shape with the complex geometry of the unsupported portions of the gussets or folds may be provided. The size and shape of the inserts is selected to generally correspond with any gaps or open spaces that will remain at the outer surfaces of the gusset or other fold(s) when the liquid enclosure is full. For example, with the standup gussets described above in connection with the package 10 of FIGS. 1A-C, the panels forming the gussets are folded in such a way as to create two somewhat triangular regions of open space at each end of the liquid enclosure 12. FIGS. 10A and 10B show a pair of foam inserts 902 that can be selectively fitted into the open spaces in the standup gusset. As shown, the foam inserts 902 are generally three-dimensional triangular structures that fit into the general locations with line P representing the periphery of the external container 14 shown in FIG. 10A. As the liquid enclosure 12 swells and expands during filling, it will typically expand outwardly into increasing engagement with the foam inserts 902, whereby the resilient foam inserts 902 are capable of providing the gusset panels with resilient support. The foam inserts 902 may be manufactured from a wide range of foams that have the desired compression and resiliency characteristics. For example, open cell or closed cell foams can be used from very soft foam with a durometer in the range of 40 to 80 on the OO scale may be used to form the foam inserts. In alternative applications, inserts manufactured from compressible, resilient materials may be used to fill gaps and other openings between the liquid enclosure and the associated surrounding structures, such as the external container and/or the end caps.

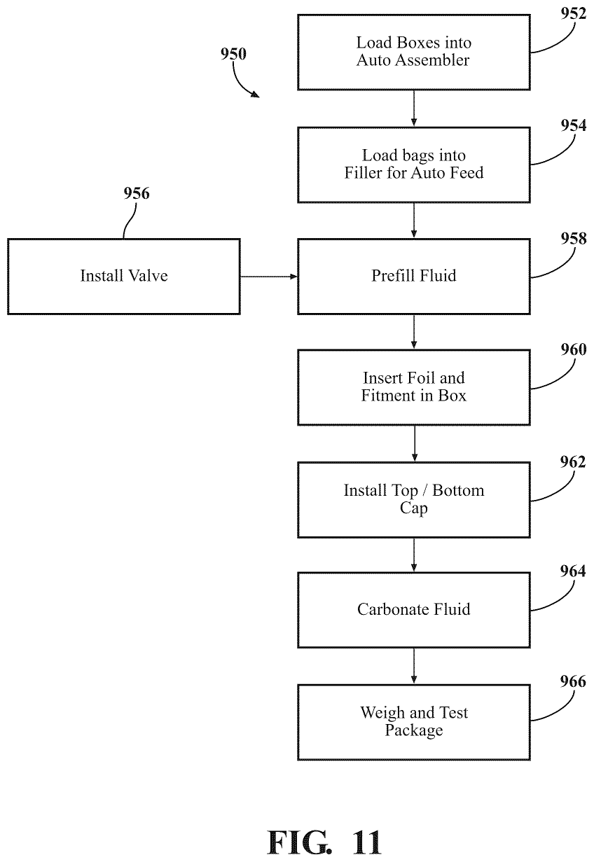

In another aspect, the present invention provides a method for assembling and filling with a carbonated beverage a package in accordance with an embodiment of the present invention. The method will be described in the context of filling a package 10″ of the type shown in FIGS. 8A-C (See FIG. 11). Although the package 10″ is capable of being implemented in a variety of alternative applications, the method will be described in the context of a package 10″ in which the liquid enclosure 12″ is a liquid container and the external container 14″ is provided as a folded or flat knocked-down sleeve with open top and bottom ends. In this context, the method includes the step of unfolding the previously manufactured flat external container. This step may also be achieved manually or may be automated using conventional box handling equipment and filling equipment. When using box handling equipment, the method includes the step of loading a plurality of the flat external containers into an auto assembler 952. In alternative applications, the external container may not be flat and may not need to be unfolded. For example, if the external container is a rigid segment of tube, it may be not be practical to flatten it for storage, and therefore would not need to be unfolded.

The liquid enclosure 12″ is also formed and stored flat so that it can be manually or automatically fed into the filler equipment and includes a valve fitment 18″ that seats a suitable valve, such as a Schrader valve. When fed and filled using automation, a plurality of the liquid containers are loaded into an automated filler 954 so that they can be automatically fed into the filling equipment. In this embodiment, the liquid enclosures are loaded into the automated filler with the valve fitment pre-installed. In other applications, the valve fitment may be installed after loading as part of the automation sequence.

In typical applications, the liquid enclosure is manufactured with a valve fitment having a seat configured to receive the desired valve. To prepare the liquid enclosure to receive fluid, the method includes the step of installing the valve 956 in the valve fitment. As noted above, the valve may be a conventional Schrader valve and it may be threadedly installed in a corresponding threaded seat in the valve fitment. The valve fitment may, in alternative applications, be fitted with other types of valves. In such cases, the valve may be seated in the valve fitment using other types of attachments.

The method also includes the step of filling the liquid enclosure with fluid 958. This step may occur before or after insertion of the liquid enclosure into the external container, but in the illustrated embodiment occurs prior to insertion. In this embodiment, the liquid is introduced into the liquid enclosure in an uncarbonated or partially carbonated state, and it is carbonated after filling as described in more detail below. In alternative embodiments, the fluid may be fully carbonated when introduced into the liquid enclosure. This filling step may be performed by connecting a conventional filling machine to the valve fitment, moving the valve into an open state and introducing fluid into the interior of the liquid enclosure through the open valve. In some applications, attachment of the filling machine to the valve fitment will simultaneously and automatically open the valve and removal of the filling machine will simultaneously and automatically close the valve. For example, in the context of a Schrader valve, the dispensing end of the filling machine may have a protrusion that automatically displaces the valve stem when the filling machine is attached to the valve fitment and automatically allows the valve stem to return to the closed state when removed.

The method further includes the step of inserting the liquid enclosure into the external container 960. As part of this step, the liquid enclosure may be slid into the interior of the external container through the open top end, and the valve fitment may be fitted through an opening in the external container, thereby making the valve and valve fitment accessible from the exterior of the package.

The method also includes the step of installing the bottom end cap 962. As discussed above, the bottom end cap is typically fitted into the open bottom end of the external container. Depending on the end cap configuration, the bottom end cap may have a peripheral lip that abuts the bottom edge of the liquid enclosure or it may have a circumferential track that entraps a bottom portion of the external container. This bottom end cap may be installed manually or using automation. In some applications, the bottom end cap may also be secured in place using fasteners, plastic welding or adhesives. In applications in which the liquid enclosure is fitted into the external container after the bottom end cap is installed, the liquid enclosure may be fitted into the external container through the top open end or the bottom open end.

To complete assembly, the method also includes the step of installing the top end cap 962 in the external container. The top end cap is typically installed by fitting it into the open top end of the external container. Depending on the end cap configuration, the top end cap may have a peripheral lip that abuts the edge of the top end of the liquid enclosure or a circumferential track that entraps a top portion of the external container. The top end cap may be installed manually or using automation. When desired the top end cap may also be secured in place, for example, using fasteners or adhesives. Although the flow chart of FIG. 11 shows the installation of the top and bottom end caps in the same step (962), the top and bottom end caps may be installed separately from one another and at different times in overall method.

As noted above, the fluid may be introduced into the liquid enclosure in an uncarbonated state (or partially carbonated state). When that happens, the method may include the step of carbonating the fluid in place within the package 964. To implement this step, a source of compressed gas (such as CO2) is attached to the valve fitment, the valve is opened and the pressurized gas is introduced into the interior of the liquid enclosure. The fluid is maintained under these conditions for a long enough period for an appropriate amount of CO2 to dissolve into the fluid. In some applications, attachment of the source of compressed gas to the valve fitment will simultaneously and automatically open the valve and removal of the source of compressed gas will simultaneously and automatically close the valve. For example, in the context of a Schrader valve, the end of the source of compressed gas may have a protrusion that automatically displaces the valve stem when attached to the valve fitment and automatically allows the valve stem to remove to the close state when removed.

Once fully assembled, filled and carbonated, the package may be subjected to any desired quality control steps, such as weighing and pressure testing 966. A tamper proof seal is applied for the consumer to remove and protect the valve assembly from contamination through distribution and shipping.

Although the method is described with the various step occurring in a specific order, it should be evident that some of the steps may be implemented in different order, and the present invention should not be limited to the specific order set forth herein. For example, the end caps can be installed at different times in the method. As another example, the valve may be preinstalled in the valve fitment or it may be formed in place as an integral part of the valve fitment.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A package for storing a carbonated beverage, comprising:
a liquid container formed from a film laminate having at least one metallic layer and at least one plastic layer, the liquid container defining an interior space suitable for storing a carbonated liquid, the liquid container being manufactured in a flat state and capable of expanding into a filled size and a filled shape when filled with a carbonated liquid;
a valve fitment sealed within a wall of the liquid container, the valve fitment providing a flow passage from the interior space to an exterior of the liquid container, the valve fitment having a valve seat;
a valve seated within the valve seat, the valve having an open position and a closed position, the valve being biased in the closed position and, when in the closed position, capable of retaining a carbonated liquid in the interior space under an internal pressure, the valve being selectively openable to permit a liquid to be introduced into the interior space and to permit dispensing of a liquid stored within the interior space; and
an external container disposed about at least a portion of the liquid container, the external container having a size and shape corresponding with the filled size and filled shape of the liquid container, whereby the liquid container and the external container cooperatively contain the internal pressure in the liquid container when the liquid container is filled.

2. The package of claim 1 wherein the liquid container is a liquid bag formed by welding a plurality of sheets of the film laminate.

3. The package of claim 1 wherein the valve is biased in the closed position by the internal pressure of a stored carbonated liquid.

4. The package of claim 1 wherein the valve is a Schrader valve.

5. The package of claim 4 further including a dispensing spout, the dispensing spout configured to be selectively connected to the valve fitment, the dispensing spout including a valve actuator configured to allow selective opening of the valve.

6. The package of claim 5 wherein the valve includes a valve stem; and
wherein the valve actuator is a plunger, the plunger being selectively movable relative to the valve to displace the valve stem.

7. The package of claim 1 wherein the external container is a sleeve having at least one of an open top and an open bottom; and
further including an end cap fitted into the at least one of an open top or an open bottom, the end cap closing the at least one of an open top or an open bottom, the end cap being disposed in the external container and secured at a position to abut with the liquid container when the liquid container is at the filled size and the filled shape.

8. The package of claim 7 wherein the end cap is a top end cap that defines a recess and includes an integrated handle, the integrated handle having at least one handle portions, the handle portion movable between a collapsed position closing at least a portion of the recess and a raised position in which the handle portion is accessible for use in carrying the package.

9. The package of claim 7 further including a structural spacer disposed between the end cap and the liquid container.

10. The package of claim 1 wherein the liquid container includes a bottom end formed from a bottom panel folded into a bottom gusset, the bottom gusset having a generally planar central portion configured to engage with a bottom end cap.

11. The package of claim 10 wherein the liquid container includes a top end formed from a top panel folded into a top gusset, the top gusset having a generally planar central portion configured to engage with a top end cap.

12. The package of claim 1 wherein the external container has at least one of an open top and an open bottom; and
further including an end cap fitted into the at least one of an open top or an open bottom, the end cap closing the at least one of the open top or the open bottom, the end cap being manually movable within the external container, whereby a user can move the end cap progressively into the external container as carbonated liquid is dispensed to maintain engagement between the end cap and the liquid container even as the liquid container collapses during dispensing.

13. The package of claim 1 wherein the liquid enclosure has a generally cylindrical shape and the external container has a generally cylindrical shape with an open top end and an open bottom end; and
wherein the open top end and the open bottom end are closed by circular end caps that are frictionally fitted into the open top end and the open bottom end.

14. The package of claim 10 wherein at least one open space is defined between the liquid container and the external container; and
wherein a foam spacer is disposed in the open space.

15. A method of providing a package with a carbonated fluid, comprising:
providing an external container in a flat configuration;
providing a liquid container in a flat configuration, the liquid container having an interior and including a valve fitment providing access to the interior;
installing a valve in the valve fitment;
filling the liquid container with a fluid via the valve in the valve fitment;
fitting the liquid container into the external container with the valve fitment exposed; and
carbonating the fluid in situ within the liquid container after the step fitting the liquid container into the external container.

16. The method of claim 15 wherein the step of carbonating the fluid includes the steps of connecting a source of compressed gas to the valve fitment, opening the valve and introducing compressed gas into the interior of the liquid container.

17. The method of claim 16 wherein the valve is a Schrader valve and the step of opening the valve includes the step of displacing a valve stem of the Schrader valve.

18. The method of claim 17 further including the steps of:
installing a top end cap in the external container; and
installing a bottom end cap in the external container.

19. The method of claim 17 further including the steps of:
providing the valve fitment with a dispensing spout seat;
installing a dispensing spout on the valve fitment on the dispensing spout seat, the dispensing spout having an integrated plunger;
manipulating the plunger to displace the valve stem of the Schrader valve; and
dispensing the fluid from the interior of the liquid container through the Schrader valve and the dispensing spout.

20. The method of claim 17 further including the step of loading a plurality of external containers in an auto assembler, the external containers being loaded in a flat state and being expanded by the auto assembler.

21. The method of claim 17 further including the step of loading a plurality of liquid containers into a filler after the step of installing the valve fitment, the liquid containers being loaded in a flat state.

22. The method of claim 21 wherein the step of filling the liquid container is further defined as filling the liquid container with an auto filler, the auto filler coupling to the valve fitment and configured to open the valve by displacing the valve stem.

23. A package for storing and dispensing a carbonated beverage comprising:
a flat liquid enclosure defining an internal space and having a valve fitment to provide access to the internal space, the valve fitment defining a liquid flow passage through which a liquid may be introduced into the internal space or dispensed from the internal space, the valve fitment defining a valve seat coincident with the liquid flow passage, the valve fitment defining a dispensing spout attachment;
a Schrader valve seated in the valve seat, the Schrader valve having a valve body and a valve stem movably disposed within the valve body, the valve stem being biased in a first position relative to the valve body to close the liquid flow passage and being selectively movable into a second position relative to the valve body to open the liquid passage;
an external container disposed about the liquid enclosure, the external container defining an internal space, the liquid enclosure being positioned within the internal space, the external container defining valve fitment opening, the valve fitment being accessible via the valve fitment opening; and
a dispensing spout removable attached to the dispensing spout attachment, the dispensing spout including a plunger, the plunger being selectively movable to displace the valve stem of the Schrader valve relative to the valve body to selectively open the liquid flow path, thereby allowing dispensing of a liquid stored in the liquid enclosure through the valve fitment, the valve body and the dispensing spout.

24. The package of claim 23 where the external container has an open top; and
further including a top end cap fitted into the open top in engagement with the liquid enclosure.

25. The package of claim 24 wherein the liquid enclosure has a gusset facing the top end cap, the gusset having a general planar central portion that engages with the top end cap when the liquid enclosure is filled.

26. The package of claim 25 wherein the top end cap is secured to the external container.

27. The package of claim 25 wherein the top end cap is selectively movable within the external container, whereby the top end cap can be moved progressively farther into the external container to maintain contact with the liquid enclosure as the liquid enclosure is progressively emptied of a stored liquid.
